(19) United States
(12) Patent Application Publication
(10) Pub. No.: US 2014/0039964 A1
(43) Pub. Date: Feb. 6, 2014

(54) ORDER MANAGEMENT IN LINER SHIPPING SERVICES

(71) Applicant: TATA CONSULTANCY SERVICES LIMITED, Mumbai (IN)

(72) Inventor: Siddhartha Sengupta, Mumbai (IN)

(73) Assignee: Tata Consultancy Services Limited, Mumbai (IN)

(21) Appl. No.: 13/719,592

(22) Filed: Dec. 19, 2012

(30) Foreign Application Priority Data
Jul. 31, 2012 (IN) 2200/MUM/2012

(51) Int. Cl. G06Q 10/08

(52) U.S. Cl. CPC G06Q 10/08
USPC 705/7.25

(57) ABSTRACT

Method(s) and system(s) for managing orders in liner based services are described herein. The method includes receiving a request for booking a shipment order. The shipment order may include booking an empty liner slot and an empty container. The method includes determining, based on an operational plan, temporal and geographical availabilities of empty liner slots and empty containers to promise the request. The operational plan is generated by evaluating availabilities and reservations of the empty liner slots to optimize revenues. Further, the operational plan is generated by performing a configurable search over the multiple dimensions and optimal intra-regional repositioning of empty containers. The method also includes providing a response to the request, based on the determination. Further, the method includes executing the request, upon acceptance of the request and continuous gathering and updating of the status of orders, demands and supplies as well as business parameters.

### CLAIM OF PRIORITY

This application claims the benefit of priority under 35 U.S.C. §119 of Indian Patent Application Serial Number 2200/MUM/2012, entitled “ORDER MANAGEMENT IN LINER SHIPPING SERVICES,” filed on Jul. 31, 2012, the benefit of priority of which is claimed hereby, and which is incorporated by reference herein in its entirety.

### TECHNICAL FIELD

The present subject matter, in general, relates to order management, and in particular to order management in liner and container-based logistics services.

### BACKGROUND

Generally, shipping logistics service providers use liners, containers, and similar equipments to serve their customers' transportation and logistics orders. Typical companies include companies that own or operate liners and containers, parcel tankers, and/or other logistics assets. Smaller companies own or operate some assets like containers and do not own or operate other assets. Generally, these shipping logistics service providers manage orders based on simple business rules, such as first come first serve, i.e., completing orders, generally online, in the sequence in which they arrive.

Some service providers make an improvement by booking pseudo orders ahead of the actual ones to ensure better service to late orders from customers providing the largest sales revenues. Popular Supply Chain Management and Enterprise Resource Planning systems also support such methods and systems of order management. As many of the policies supported are myopic and lead to a tendency to lose out on good but future opportunities while serving bad but immediate ones, such order management rules may not provide optimization of the process. This may prevent the shipping service providers from improving the service level provided to customers. Also, the shipping service providers fail to generate higher revenues and margins from more scientific allocations of their expensive assets as also to improve the service level they provide to their customers, the shippers.

### SUMMARY

This summary is provided to introduce concepts related to systems and methods for order management in liner shipping services. The concepts are further described below in the detailed description. This summary is not intended to identify essential features of the claimed subject matter nor is it intended for use in determining or limiting the scope of the claimed subject matter.

In an embodiment, method(s) and system(s) for managing shipment orders in liner based services are described herein. The method may include receiving at least one request for booking a shipment order. The shipment order may include booking at least one empty liner slot and at least one empty container. Further, the method may include determining, based on an operational order management plan, temporal, and geographical availabilities of empty liner slots and empty containers to promise the at least one request. The operational order management plan may combine immediate-term forecasts and the at least one request for identifying logistic capacities and resources to be allocated to the at least one request. Furthermore, the operational order management plan may be generated by analyzing forecasts and actual status of demand and availabilities of empty liner slots and empty containers over immediate time horizons as stored in a database. Further, the operational order management plan may be generated by evaluating and adapting availabilities and reservations of the at least one empty liner slot in accordance with an empty liner slot plan. The empty liner slot plan may be based at least on revenue management and optimization of one or more variables. The operational order management plan may include evaluating and adapting multi-dimensional availabilities and the reservations of the at least one empty container in consonance with an empty container plan. The empty container plan may be based on a configurable search over the multiple dimensions and optimal intra-regional repositioning of empty containers.

Additionally, the method may include providing a response to the request, based on the determination. The response may include one of an acceptance of the at least one request, a negotiation of the at least one request, and a rejection of the at least one request. The method may also include executing the at least one request upon acceptance of the at least one request. The executing may include updating information related to the at least one empty liner slot and the at least one empty container. Thus, the method is an integrated method of planning, booking and execution of shipment orders.

### BRIEF DESCRIPTION OF THE DRAWINGS

The detailed description is provided with reference to the accompanying figures. In the figures, the left-most digit(s) of a reference number identifies the figure in which the reference number first appears. The same numbers are used throughout the drawings to reference like features and components.

FIG. 1 illustrates a network implementation of an order management system in shipping logistics service-providing industries, in accordance with an embodiment of the present subject matter.

FIG. 2 illustrates various phases of the order management system, in accordance with an embodiment of the present subject matter.

FIG. 3 shows a flowchart illustrating a method for order booking for liner companies, in accordance with an embodiment of the present subject matter.

FIG. 4 shows a flowchart illustrating a method for order selection during batch processing, in accordance with an embodiment of the present subject matter.

FIG. 5 shows a flowchart illustrating a method for liner empty slot planning, in accordance with an embodiment of the present subject matter.

FIG. 6 shows a flowchart illustrating a method for empty container redistribution planning, in accordance with an embodiment of the present subject matter.

FIG. 7 shows a flowchart illustrating a method for sequential N-dimensional (ND) search before booking an order, in accordance with an embodiment of the present subject matter.

### DETAILED DESCRIPTION

With the increasing globalization of trade and increasing competition among various shipping logistics service providers, effective order management has become one of the critical success factors for shipping logistics service-providing industries. However, effective order management is extremely challenging and complex. With the proliferation of global trade routes, shipping alliances, demanding customers, differentiated product requirements, and stiff market competition, scientific methods of order management in the shipping logistics service-providing industries provide an opportunity to improve falling revenues and margins as well as to overcome widely reported shortcomings in service quality.

The conventional approaches and practices for order management in the shipping logistics service-providing industries include elements of both mid-term predictive tactical and short-term operational order management planning, but not in a very integrated and scientific manner. As these services involve transportation and other geographically-spread services, uncertainty appears in multiple dimensions, such as demand and supply, prices and costs, quantities, and lead times. While tactically, many uncertainties can be mitigated, for example with distributed safety stocks of liner slots, containers and other capacities and resources, the process is often over-simplified and suboptimal. For example, a first-come-first-serve (FCFS) policy is widely applied at the operational level. The FCFS policy with pre-processing pseudo orders for more valuable customers in anticipation of the actual orders gives only limited benefits. Also, much of the order promising being on-line with rapid response limits the opportunities to optimize revenues or customer service.

Thus, in situations particularly where demands exceed supplies, and also in many other situations, these conventional approaches may be unable to maximize either returns to the service provider or the logistics service reliability to the shippers. As a result, the shippers experience unreliability of services and the service providers may lose opportunities to improve revenues and margins from inefficient asset utilization. Due to the complexities of both scale and scope, the management, such as planning, allocation, and usage of various resources, becomes complicated and sub-optimal. Therefore, an integrated, scientific and efficient combination of order management systems and processes may be required for enhancing overall revenue and service reliability.

In various implementations, the present subject matter discloses an order management system. The present subject matter provides an integrated set of processes that may facilitate in planning and managing promising and fulfillment of ocean shipping orders and manage an information base. The order management system may implement general principles of revenue management for the perishable capacities, such as liner slots, and advanced available-to-promise for the resources like containers, along with associated scientific tactical and/or operational order management planning for some or all of the assets. In cases, when segmented demand exceeds supply especially, but not limited to, for perishable assets, capacities and resources, the order management system may also take into account demand segmentation and may selectively promise orders and allocate resources to such orders. The order management system may perform the task of order management in two phases, viz. forecast based and order based. The forecast based order management may include demand and supply forecasts that may be helpful in driving tactical allocations and reservations of liner slots and containers based on demands at ports and terminals serviced. Further, actual orders, followed by monitoring, tracking and record keeping, may be used to continuously and reactively improve upon the forecast-based predictive tactical order management plans for order booking or promising and order fulfillment or execution.

A request for booking is handled by a sales agent, at different loading or freight origins. The request may be a request for booking a shipment order. The shipment order may include a description in multiple dimensions, including the number and type of liner slots and containers. The task of order promising is augmented with an exhaustive search for liner slots, containers and other capacities and resources in multiple dimensions, such as time buckets, locations, available assets and alternative assets. Based on the exhaustive search the sales agent may or may not confirm the booking. Accordingly, the order promising may refer to negotiations, if necessary, and making a commitment of quantity and due date, among other commitments, to a customer, such as a shipper, for the transportation of goods, from an origin to a destination. The exhaustive search may lead to rejection of a request or order. In an implementation, the order promising may be on line, batched, or sometimes on line and sometimes batched.

Once the order is promised to the customer, various capacities and resources are allocated to meet the commitment. Therefore, the order fulfillment refers to the allocation of specific liner slots, containers, and other capacities and resources to meet the commitment, together with performing such tasks and activities that ensure that the transportation and logistics tasks are completed as promised. The task of order fulfillment is augmented with a multi-dimensional search for liner slots, containers and other capacities and resources and exception handling capabilities. Whenever there is change of status of an order, slot, container or other capacities or resources, it is monitored, tracked and reflected in the database for global record keeping.

Thus, the present subject matter integrates several systems, methods and information, including the systems for continuous monitoring and tracking of orders, usage of containers, liner slots, associated resources, and capacities. The order management system also integrates the data and information for priority-segmented, temporally and geographically-distributed, dynamic and persistent inventory of available and allocated, containers, liner slots and associated resources and capacities of different types. The order management system additionally integrates methods for revenue management, advanced available-to-promise and scientific tactical and operations management to ensure maximum profitability and service reliability.

The order management system described herein can be used in shipping logistics service-providing industries for managing customer orders with priority allocation to maximize returns, where opportune, for example, in industries having a continuous flow of stochastic, geographically-unbalanced and value-segmented demand whose history is available allowing the demand to be forecasted; uncertain supply and allocation; advance sales/bookings/promises; a fixed capacity with high capacity-change costs; a geographic hierarchy of operations, and perishable and substitutable assets. Examples of the perishable and substitutable assets may include, but are not limited to, liner slots, similar capacities on trains and trucks, static locations, and containers. Further, the order management system may enable reaping various unexplored dimensions of revenue and profitability in the shipping logistics service-providing industries. Additionally, the order management system can improve the reliability of services offered and the utilization of assets in a geographically dispersed service network.

The present subject matter may be based on, among other things, methods and systems to determine situations of opportunity based on which orders may be prioritized. When opportune, the system may select, promise and fulfill the order based on the priority-segmented, temporally and geographically-distributed, dynamic and persistent inventory of available and allocated, containers, liner slots and associated resources and capacities of different types. Further, the present subject matter provides continuous monitoring and tracking of orders and usage of containers, liner slots and associated resources and capacities. Dynamic and operational master-plans may be computed and continuously updated to optimally balance the demand and supply, based on forecasts of demand and actual orders already received for shipping services, and the supply of empty liner slots or other logistics capacities and empty containers or other logistics resources. In addition, some or all of these containers, liner slots and associated resources and capacities are promised and allocated to maximize long and/or short time revenue and service reliability. Thus, the method is an integrated method of planning, booking and execution of shipment orders.

While aspects of the described systems and methods for order management in shipping logistics service-providing industries can be implemented in any number of different systems, environments, and/or configurations, the embodiments are described in the context of the following system architecture(s).

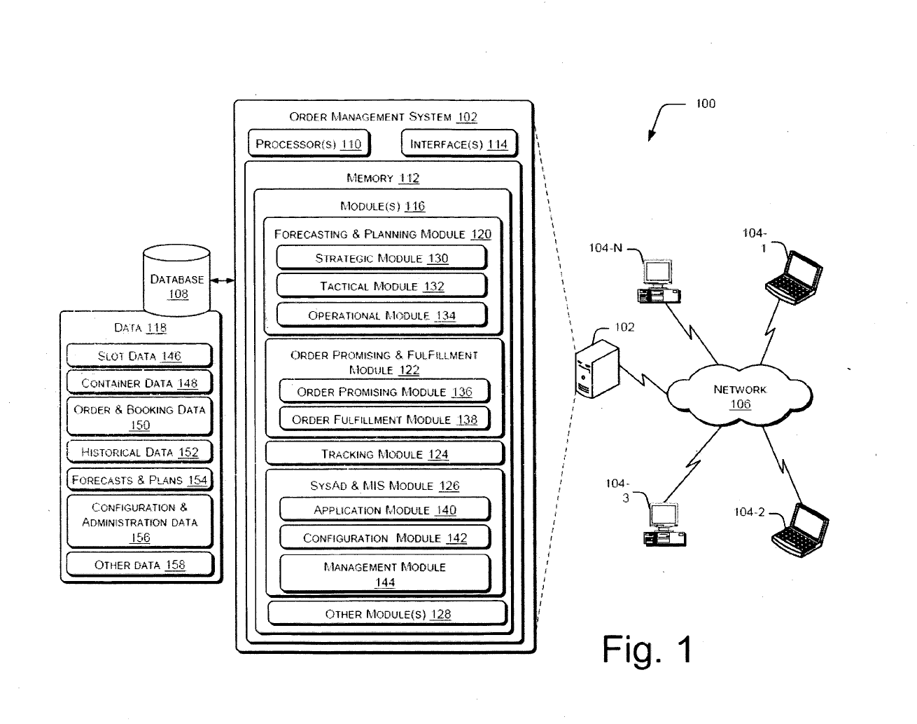

According to an embodiment of the present subject matter, FIG. 1 illustrates a network environment 100 implementing an order management system 102. In an example, the shipping logistics service-providing industries, for example, liner shipping, may implement the order management system 102 for booking and executing freight shipping orders in an organizationally, geographically, and temporally integrated and collaborative manner. Accordingly, the order management system 102 may facilitate utilization of opportunities to make higher revenues and margins from more scientific allocations of their expensive assets as also to improve the service level provided to the customers, such as the shippers.

In one implementation, the network environment 100 may be a company network, including various office personal computers, laptops, various servers, and other computing devices. Examples of a company may include a shipping logistics service provider company. It will also be appreciated by a person skilled in the art that the company may be any company involved in any line of shipping business. In another implementation, the network environment 100 may include a public network, such a public cloud.

The order management system 102 may be implemented in a variety of computing systems, a mainframe computer, a server, a network server, or a suitable alternative with sufficient computing capability and storage capacity. Further, it will be understood that the order management system 102 may be connected to a plurality of user devices 104-1, 104-2, 104-3, . . . , 104-N, collectively referred to as the user devices 104 and individually referred to as a user device 104. The user devices 104 may be used by users, such as sales or sales-agent user, a service-provider's operations personnel, planners and business managers. In one implementation, the order management system 102 may be included within an existing information technology infrastructure with an integrated global enterprise database management subsystem 108 and a global communications network 106.

The user devices 104 may also be implemented as any of a variety of conventional computing devices, including, for example, workstations, desktop computers, laptops, or suitable alternatives with sufficient computing capabilities and local storage capacities. Various sales and operations managers and personnel may use the user devices 104 to implement order management in the geographically-spread and hierarchically structured shipping logistics service provider's organization. Alternatively, for smaller companies the order management system 102 and the associated user devices 104 may be implemented at a relatively smaller scale with a limited number of personal computers. In one implementation, the plurality of user devices 104 supported by the order management system 102 may be used by business managers or planners for predictive tactical order management planning of liner slots, containers and other capacities and resources. Various business managers and planners may use the user devices 104 to distribute and, if appropriate, reserve portions of the geographically and temporally spread availabilities of liner slots, containers and other capacities and resources of different types for different markets.

As shown in the figure, the user devices 104 are communicatively coupled to the order management system 102 over a global communications network, such as a network 106 through one or more communication links for facilitating one or more end users to access and operate the order management system 102. The network 106 of a service provider may interconnect various enterprise subsystems and may enable integrated communications and information sharing in the order management system 102 and its associated systems and sub-systems. In one implementation, the network 106 may be a wireless network, a wired network, or a combination thereof. The network 106 may also be an individual network or a collection of many such individual networks, interconnected with each other and functioning as a single large network, e.g., the Internet or an intranet.

The network 106 may be implemented as one of the different types of networks, such as intranet, local area network (LAN), wide area network (WAN), the internet, and such. The network 106 may either be a dedicated network or a shared network, which represents an association of the different types of networks that use a variety of protocols, for example, Hypertext Transfer Protocol (HTTP), Transmission Control Protocol/Internet Protocol (TCP/IP), etc., to communicate with each other. Further, the network 106 may include a variety of network devices, including routers, bridges, servers, computing devices, storage devices, and the like.

In an implementation, the order management system 102 may be coupled to a global integrated database, such as a database 108. Although not shown in the figure, it will be understood that the database 108 may also be connected to the network 106 and all other networks in the network environment 100. The user devices 104 are also communicatively coupled to the database 108 over the network 106. The database 108 may serve as a unifying and integrating storage of high quality data and information utilized or generated by the order management system 102 and other all enterprise sub-systems.

The database 108 may store real-time updated information including, but not limited to, historical demands, orders, their origins-destinations, lead times, quantities, changes and their revenue contributions; customer information; operating transportation network information, travel time and costs for different routes, including multi-hop or trans-shipment options, in the shipping service network; business constraints, rules, policies; the availabilities and allocations of containers, liner slots and associated resources and capacities forecasted demand and supply capacity; and orders under process and of different status. In an implementation, the database 108 may include record of status of each order from arrival to rejection/completion. The database 108 may maintain the status names and order status of the order management system 102.

In an implementation, the database 108 may be provided as a relational database and may store data in various formats, such as relational tables, object oriented relational tables, indexed tables. Further, it will be understood that the database 108 may be provided as any of various other types of databases, such as operational, analytical, hierarchical, distributed or network databases. It will be appreciated that although the database 108 is shown as external to the order management system 102, the database 108 is an integral and tightly coupled element of the enterprise resource and capacity planning system of the shipping logistics service provider. It will also be appreciated that although the database 108 is shown as one database for storing all types of data, the database 108 can also be implemented as a plurality of databases with each database storing a particular type of data, such as asset data, order data, customer data, historical business data, and policy data. Further, the database 108 may include one or more data warehouse(s) and data marts and may be centralized or decentralized.

In an implementation, the order management system 102 includes a processor(s) 110 coupled to a memory 112. The order management system 102 further includes an interface(s) 114. Further, the interface(s) 114 may include a variety of software and hardware interfaces, for example, interfaces for peripheral device(s), such as a keyboard, a mouse, an external memory, a display, and a printer. Additionally, the interface(s) 114 may enable the order management system 102 to communicate with other devices, such as web servers and external repositories. The interface(s) 114 may also facilitate multiple communications within a wide variety of networks and protocol types, including wired networks, for example, LAN, cable, etc., and wireless networks, such as WLAN, cellular, or satellite. For the purpose, the interface(s) 114 may include one or more ports.

The processor(s) 110 may be implemented as one or more microprocessors, microcomputers, microcontrollers, digital signal processors, central processing units, state machines, logic circuitries, and/or any devices that manipulate signals based on operational instructions. Among other capabilities, the processor(s) 110 may be configured to fetch and execute computer-readable instructions stored in the memory 112.

The memory 112 may include any computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. Further, the memory 112 includes module(s) 116 and the database 108 may include data 118.

The module(s) 116 include, for example, a forecasting and planning module 120, an order promising and fulfillment module 122, a tracking module 124, a SysAd & MIS module 126, and other module(s) 128. The other module(s) 128 may include programs or coded instructions that supplement applications or functions performed by the order management system 102. The forecasting and planning module 120 may include a strategic module 130, a tactical module 132, and an operational module 134. The order promising and fulfillment module 122 may include an order promising or booking module 136 and an order fulfillment or execution module 138. Further, the SysAd & MIS module 126 may include an applications module 140, a configuration module 142, and a management module 144. Although the above-mentioned modules are shown internal to the order management system 102, in alternative implementations, each of these modules may be implemented by different computing devices or sub-systems that may be connected to the network 106.

The data 118 may include liner slot data 146, container data 148, order and booking data 150, historical data 152, forecasts & plans 154, configurations & administration data 156, and other data 158. The other data 158, amongst other things, may serve as a repository for storing data that is processed, received, or generated as a result of the execution of one or more modules in the module(s) 116. As shown in the figure, the data 118 resides in an external repository, such as the database 108, which may be coupled to the order management system 102. The order management system 102 may communicate with the database 108 through the interface(s) 114 to obtain information from the data 118.

In one implementation, the order management system 102 may be distributed geographically, i.e., decentralized on a regional or global basis. The order management system 102 may store, read, and manage all common as well as specific data and information using the database 108 that may be logically integrated and centralized, but in specific implementations, is physically distributed to support all instances of the order management system 102. Users, such as sales and operations managers may access the order management system 102 using the user devices 104 over the global communications network, such as the network 106, and implement order management on a regional or global basis, hierarchically or otherwise. Further, the order management system 102 and logic may be replicated at the various Sales and Operations locations and nodes of the geographically-spread and hierarchically or otherwise structured shipping logistics service providers.

The configuration module 142 of the SysAd & MIS module 126 may facilitate the order management system 102 may receive a shipper's booking request/order from a sales or sales-agent user using device 104. The order management system 102 may support the user to optimally process the request/order towards acceptance and confirmation or rejection. At different stages of life of the order, the service-provider's operations personnel may check status of a booked order through the user device 104. The operations personnel may execute different aspects of the confirmed orders and also perform internal tasks, such as like the movement of empty containers and resources. Further, the order management system 102 may allow the configuration of a multiplicity of status of each order from arrival to rejection or completion and finally into a historical record.

In another implementation, the SysAd & MIS module 126 may allow the management and configuration of the order management system 102 and the other subsystems. The management and configuration may be performed through appropriately designed user interfaces, such as interface(s) 114. The database 108 may also store the various configurations of the order management system 102. Examples of the configurations may include, but are not limited to, the type of operation of and types of capacities and resources employed the service provider; temporal horizons for strategic/tactical/operational order management planning; the selection of the temporal granularities for forecasting and planning; the type and nature of planning models used; names of the various possible status that may be assigned to liner slots, containers and other capacities and resources; the weights for order valuation; the order of searches for containers and other resources. The configurations may be retrieved from the database 108 as and when required by the order management system 102.

In one implementation, the forecasting and planning module 120 may forecast shipping demand and plan supply at different temporal granularities. The strategic module 130 may forecast and analyze longer-term expectations of shipping demands and determines predictive supply-side response plans. The strategic module 130 may provide plans for the strategic and temporally and geographically-distributed acquisition and deployment of capital assets at selected shipment origin and destination markets. Examples of the capital assets may include, but are not limited to, liners, liner slots, containers, and similar capacities in trucks and trains. The strategic module 130 of the forecasting and planning module 120 may provide predictive strategic order management forecasts that may be of high temporal granularity, e.g., monthly, of, but not limited to, measures of the expectations of shipping demand volumes and prices between geographic locations, by required resource type, together with the constraints and costs of doing so. The strategic module 130 may use a combination of methods including, for example, time series with/without endogenous and exogenous variables, subjective judgmental methods and/or their combinations.

Using the data in the database 108, the strategic module 130 uses techniques of optimization, for example, mixed integer linear programming, meta-heuristics, heuristics, and simulation with various formal business models, to generate the best asset acquisition and deployment plans at the strategic level. Examples of the plans may include, but not limited to, liner service routes and frequencies; vessel sizes and numbers; container fleet requirements by type, geographic distributions for loading and repositioning; and services to be made available to alliance partners. Further, the strategic module 130 may specify the nature and extent of logistics service business to be performed in the planning period and makes provisions for the appropriate base of logistics assets, including of liners and containers, to achieve the business goals. The strategic module 130 may get configuration and history data information from the database 108 and may also store plans and other results back into the database 108.

In an implementation, the tactical module 132 of the forecasting and planning module 120 may forecast and analyze demands and supply-side positions of assets over intermediate time horizons to make predictive modifications and detailing of the predictive strategic order management plans to adapt liner slot and container availabilities to the changes foreseen over the nearer horizon, as configured. The tactical module 132 may forecast at specified temporal or geographic granularities, for temporal planning horizons; with multi-dimensional aggregations before forecasting and disaggregation of forecasts, for all types of liner slots, containers and other capacities and resources, and a selection of standard forecasting approaches and algorithms. The tactical module 132 may read configuration and history data from the database 108 and may write the forecasts back into the database 108.

In an implementation, the forecasts from the tactical module 132 may be used for predictive tactical order management planning of full and empty liner slots, for loaded and empty containers, other capacities, for every element of the shipping network and every type of asset of the logistics service company. The tactical module 132 may compute primarily the mid-term forecasted availability of liner slots, containers and other capacities and resources that may be promised, allocated and consumed or deployed to serve the shipping orders. This computation for the optimal liner slots/capacities and containers/resources may be performed using company-customized methods from a system-supported selection that may include the use of linear programming, integer programming, constraint propagation, heuristics, and meta-heurists or combinations thereof. The tactical module 132 may plan and mark for execution physical movements, between identified ports, of each type of empty containers and other resources, to dynamically balance the geographic demand and container-distribution patterns.

The forecasting and planning module 120 may use the operational module 134 for short-term forecasting and planning of shipping demand and supply at different temporal granularities, including daily and weekly, as configured. These forecasts may be based upon the data stored in the database 108. The operational module 134 may combine intermediate-term forecasts and actual order and logistics status information to support both the booking request and order implementation processors, by systematically and scientifically identifying the best logistic capacities and resources to be allocated to promise and implement orders as promised. The output of all analyses and plans are also stored back into the database 108.

In an implementation, the operational module 134 may employ a combination of methods including, analysis of distribution functions for booking order arrival, size and lead time; time series analysis with/without endogenous and exogenous variables; subjective judgmental methods and/or their combinations; aggregation of data in different dimensions prior to forecasting & disaggregation of the forecasts using statistics or configurable business rules. The operational module 134 may get historical demand data or their descriptors from the database 108. Accordingly, the supply forecasts may be based on the data stored in the database related to actual and expected status of various logistic capacities and resources like liners, liner slots and containers. These forecasts would be used to repeatedly and reactively update the plans, initially developed by the tactical module, to obtain the availabilities of optimal liner slots/capacities and containers/resources for allocation or use to service specific booking requests and orders. The computations may use company-customized methods from a system-supported selection that may include arithmetic book-keeping, the use of linear programming, integer programming, constraint propagation, heuristics and meta-heurists or combinations thereof.

As mentioned above, the order promising & fulfillment module 122 may include the order promising or booking module 136 and the order fulfillment or execution module 138. While the order promising module 136 and the order fulfillment module 138 are shown as modules in the order promising & fulfillment module 122, it will be understood that they can be implemented as separate sub-systems constituting the order management system 102 or as sub-systems of the operational module 134. In operation, the order promising module 136 may receive an order, which is a service or booking request made by a customer. In one implementation, the order promising module 136 may update the database 108, to store the incoming orders. The order promising module 136 may further assist in committing the order based on the availability of capacities and resources. The order promising module 136 may support capture, valuation, prioritization, negotiation, acceptance, modification, and/or rejection of booking requests and promising of orders.

Once the order is promised, the order fulfillment module 138 determines the best way to execute an order in terms of reliability, profitability, and service level agreements. The order fulfillment module 138 may use available logistic capacities and resources to efficiently and reliably execute promised orders. For this, the order fulfillment module 138 can also plan physical movements of empty resources to ensure the availability of such assets on the due date, based on an optimal asset allocation policy. The order promising & fulfillment module 122 may update the resource asset allocation and movement plans online so that updated information is available in real-time for subsequent order bookings and execution. The order promising & fulfillment module 122 may be configured to store the data related to booking of containers as the order and booking data 150.

In an implementation, the tracking module 124 may accumulate data from the users, such as the sales users, operations users, and various associated personnel, but not limited to, maintenance staff, booking & handling agents, alliance partners and shippers. This data relates to, but is not limited to, the liner arrivals and departures, expected arrival and departure time, the status and allocated or available quantities of liner slots, containers and other capacities and resources, the status of booking requests and orders during promising and implementation phases, actual deviations from planned activities. All the updates are maintained and managed in the database 108 over the network 106. Further, the tracking module 124 may capture real-time status information of the different requests, orders and logistic capacities and resources and can update the status information into the database 108. The real-time status information can include, for example, number and type of available unallocated or allocated full or empty liner slots on different liners or containers at different locations or in-transit, location readings from asset tracking hardware device readers, such as Radio Frequency Identifiers (RFID) and the like.

Further, the applications module 140 as indicated in the SysAd & MIS module 126 may include generic Enterprise & Supply Chain Management Information and Planning systems. The configuration module 142 may enable the configuration of various modules, such as the forecasting & planning module 120, the order promising & fulfillment module 122, the tracking module 124, and other MIS and planning systems. Furthermore, the management module 144 may assist in managing the hardware, software, operating system, data base, communications and other systems and sub-systems.

As mentioned above, the forecasting & planning module 120, the order promising & fulfillment module 122, the tracking module 124, and the SysAd & MIS module 126 may retrieve as well as store updated information into the database 108. The updated information may be related to the slots, containers, bookings, demand & supply, forecasts and plans, configurations and all other output as the slot data 146, the container data 148, order & booking data 150, historical data 152, forecasts & plans 154, configuration & administration data 156, and other data 158 including service routes, frequency and capacity of services on such routes, and the like.

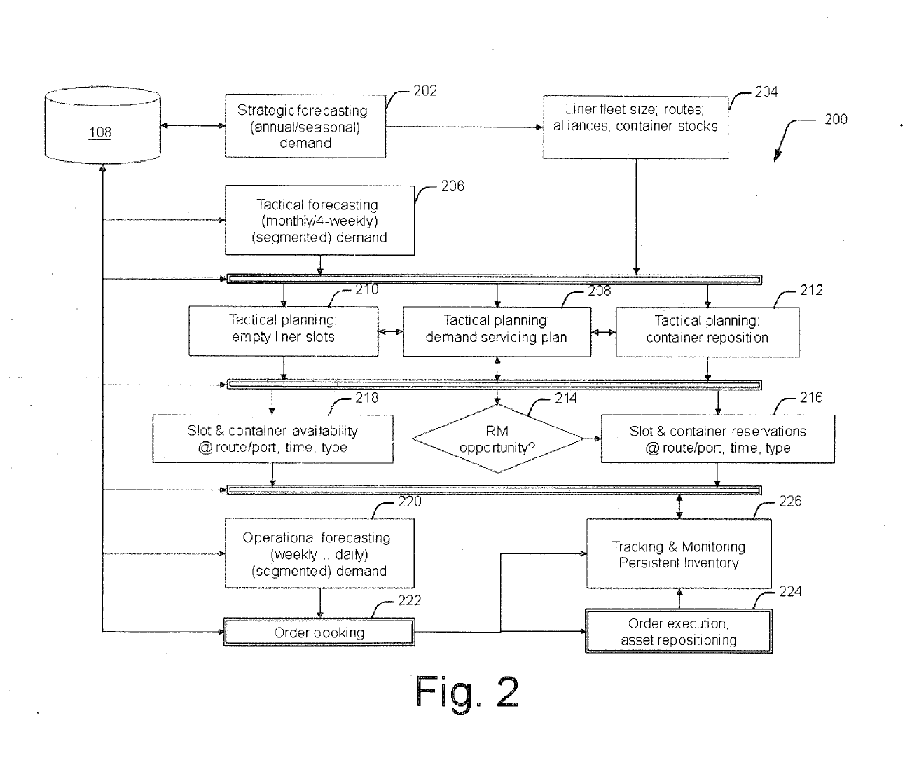

FIG. 2 illustrates various phases of the order management system 102, in accordance with an embodiment of the present subject matter. The order management system 102 may support 3-phase planning and implementation of order booking and execution to maximize returns to the service provider and the reliability of logistics service for the shipper. As explained with respect to FIG. 1, the order management system 102 may include a strategic phase, a tactical phase, and an operational phase. In the strategic phase, at block 202, annual or seasonal shipping demands may be forecasted by the strategic module 130. As indicated in block 204, the strategic module 130 may forecast optimal fleet size of liners, routes to be taken by the liner fleets, alliances with other logistics service providers, number of slots in each of the liners, stocks to be carried by containers in the liners, and the like. It will be evident that the strategic module 130 may forecast and design the long term business goals based on the data stored in the database 108.

At block 206, the tactical forecasting and planning of various liner based services may be performed for use by the tactical planners. The tactical module 132 may forecast the demand on a monthly or similar duration of time, for full and empty liner slots, other capacities, for loaded and empty containers, other resources for every element of the shipping network, and every type of asset of the logistics service company.

In an implementation, the mid-term predictive tactical order management planning of liner slots, containers and other logistic capacities and resources are supported by user-configurable tactical demand forecasting 206 at specified temporal or geographic granularities, for temporal planning horizons; with multi-dimensional aggregations before forecasting and disaggregation of forecasts, for all types of liner slots, containers and other capacities and resources, and a selection of standard forecasting approaches and algorithms. Block 206 reads the configuration and history data from the database 108 and writes the forecasts back into the database 108.

Further, at block 208, the predictive tactical master-plan forecast for demand-servicing is accumulated from the multiplicity of plans developed based on the tactical forecasts of the availabilities and reservations of liner slots, containers, other capacities and resources. This master-plan forecast may be considered as the basis for reliable and efficient order booking and execution. This information may be appropriately linked to the distributed elements of the entire logistic transportation system and network, its lanes and ports, by time intervals of configurable granularity, and by slot/capacity and container/resource type.

The tactical phase may further include planning of the empty liner slots, based on the master-plan forecast, as indicated at block 210. At block 210, the mid-term forecasted availability of liner slots and other capacities and resources may be computed. The mid-term forecasted availability may be promised, allocated, and consumed or deployed to serve the shipping orders. This may include computation of optimal temporally and geographically-distributed availabilities and reservations of empty liner slots and other logistic capacities. This may include employing the principles of revenue management using user-configurable and customizable optimization algorithms to solve dynamic or static models, as applicable for a liner company. Example of planning of empty liner slots may include identification of total number of empty slots in a liner, number of empty slots at the origin, number of empty slots at various ports during a particular route of the liner, and so on.

Further, at block 212, repositioning of containers may be decided by computing the mid-term forecasted availability of containers and other resources that can be promised, allocated, and consumed or deployed to serve the shipping orders. It will be evident that the repositioning of the containers is based on and updates the master plan as mentioned in block 208. The repositioning of the containers may be computed to maximize the servicing of optionally segmented demand as thus maximize revenue generation, using user-configurable optimization algorithms to solve dynamic or static models. The repositioning of the containers may include movement of the containers between identified ports, of each type of empty containers and other resources, to dynamically balance the geographic demand and container-distribution patterns.

At block 214, it is identified whether there is any indication of applying revenue management (RM) or not. If scope of RM is identified, the reservations of liner slots and other capacities together with those of containers and other resources are computed at block 216. The opportunities in RM may include, demand exceeding supply in a particular combination of location, type and nature of capacity or resource demanded or by the class of orders, ordinary and priority. Further, reservations for each type of containers and other resources are made for configurable time periods, at specified inventory locations where demands originate. This process of reservation of capacities and resources use company-customized methods from a system-supported selection that are driven by the goals of achieving differentiated service levels by order class and employ, for example, linear programming, integer programming, dynamic programming, constraint propagation, heuristics and meta-heuristics, closed-form expressions or combinations thereof together with selected distribution functions for demand and lead time to serve. All reservations are logical in the sense that they are not physically created immediately, but are made available in due time, often by transporting assets from one geography to another at own cost and volition.

In an implementation, the availability of liner slots and capacities together with those of containers and other resources are determined at block 218. The determination may include calculating and checking the availability of liner slots and capacities. Further, availability for each type of containers and other resources are identified for configurable time periods, at specified inventory locations where demands originate. This process of reservation of capacities and resources use company-customized methods from a system-supported selection that are driven by the goals of achieving differentiated service levels by order class. It will be evident that the master-plan forecast as discussed above may be developed based on the reservations and availabilities identified at blocks 216 and 218 respectively. Additionally, at block 220, short-term forecasts, such as daily and weekly, of shipping demand and supply are made by the operational module 134. As mentioned above, the short-term forecasts at the block 220 may be configured from data in the database 108. The short-term forecasts may be received at blocks 222 and 224.

At block 222, a sales user may book an order using the user device 104. The order promising module 136 may facilitate the sales user to book the order. Further, at block 224, operations personnel using the user devices 104 are supported by the order fulfillment module 138 that may allow the operations personnel to perform associated and internal tasks, such as reposition of empty containers and other resources. It will be understood that the order promising module 136 and the order fulfillment module 138 of the order management system 102 may be implemented on the same or different computing devices with sufficient computing capability and storage capacity and connected to the database 108 over the service provider's global communications network 106 that interconnects all its enterprise subsystems.

In an implementation, the instances of both the order promising and order fulfillment at blocks 222 and 224 respectively may trigger the tracking module 124, at block 226, to capture the change of status of booking requests and orders, various logistic capacities and resources like liners, liner slots, and containers within the process of order booking and execution, and to update the same in the database 108 over the network 106. It will be evident to a person skilled in the art that the various logistic capacities and resources are not limited to the above examples and may include trains, trucks, containers of different capacities, static locations like depots and ports, liner slots of different types, and the like.

The order management system 102 may facilitate execution of tactically and operationally developed plans within this overall process of doing business. At shorter tactical durations, users, such as business managers, may use various tactical and operational forecasts and plans, developed by the tactical module 132 and the operational module 134, to take stock of the dynamic market and make appropriate changes to the deployments of these assets and to enable revenue and service-level performance at the operational level. On a continuously interactive mode, users, such as sales, operations, and/or agents, use the ordering module 122 to capture, negotiate, book, promise, and execute or fulfill shipping orders to maximize revenue, margin and service level.

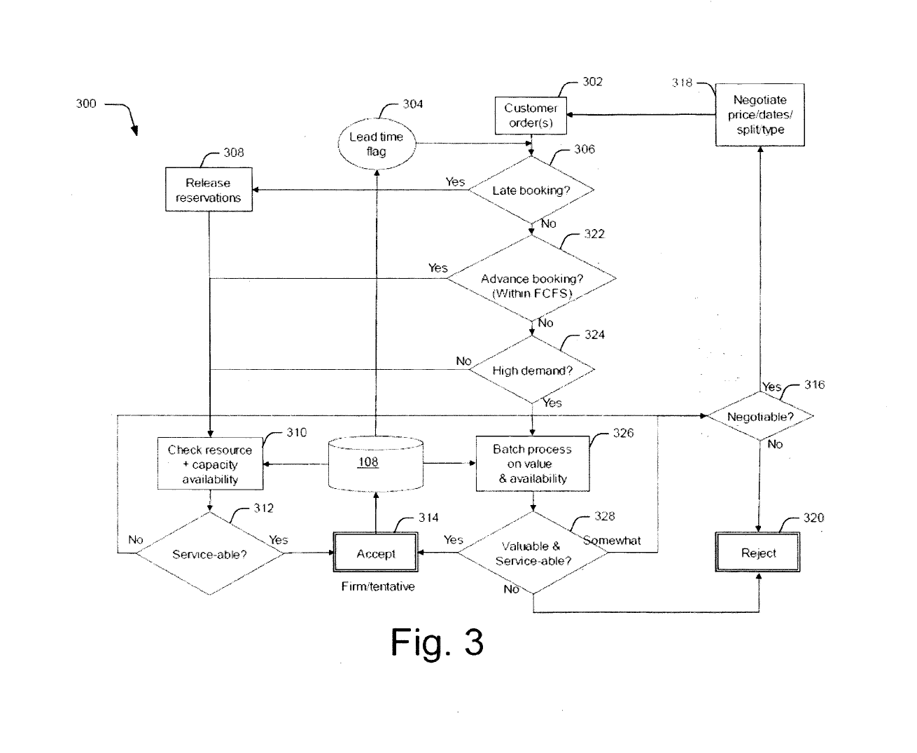

FIG. 3 shows a flowchart illustrating a method 300 for order booking for liner companies, in accordance with an embodiment of the present subject matter. The method 300 may be described in general context of computer executable instructions. Generally, computer executable instructions can include routines, programs, objects, components, data structures, procedures, modules, functions that perform particular functions or implement particular abstract data types. The method 300 may also be practiced in a distributed computing environment where functions are performed in geographically-structured organizations typically seen in liner companies, by remote processing devices that are linked through a communication network. In a distributed computing environment, computer executable instructions may be located in both local and remote computer storage media, including memory storage devices.

The order in which the method 300 is described is not intended to be construed as a limitation and may be performed in various ways. Moreover, any individual method block may include various sub-steps that may be performed in different ways to implement the method 300 or alternative methods. Additionally, individual blocks may be deleted or combined from the method 300 without departing from the spirit and scope of the subject matter described herein. Further, the different ways to implement the method 300 may be obvious to a person skilled in the art. Furthermore, the method 300 can be implemented in any suitable hardware, software, firmware, or combination thereof.

In an implementation, FIG. 3 depicts details of the order capture, negotiation and booking or promising module 136. At block 302, an order may be received, which may be a service or booking request made by the customer, possibly for a specific offered class, such as express or ordinary. Further, the requests may include both enquiries for service availability and pricing as well as to place firm orders. FIG. 3 depicts the enquiries about the pricing and the placement of orders that is more complex, and those skilled in the art will recognize from the details provided how simple enquiries are processed. At block 304, lead time for an order may be determined. The lead time may be understood as the latency between initiation and execution of the order.

Based on the lead time, at block 306, an analyzer module may determine whether the lead time is less than a user-configurable lower threshold or not. If the lead time is identified to be less than the user-configurable lower threshold, the method 300 may move to block 308. At block 308, it may be checked and ensured if inventory reservations for demand segments, such as express and ordinary, have been released for the time bucket from where capacities and resources for this order were to be allocated. Accordingly, the method 300 may proceed to block 310 to search the persistent inventory for availability of capacities and resources that may be allocated to the order. It will be evident that the availability of capacities and resources may be determined from the database 108.

Further, at block 312, based on the search results, it is determined whether the available assets can satisfy the order-specified due date, quantity, and type at the loading location of the order or not. If it is determined that the order may be serviced, at block 314 the order will be accepted and promised on first-come-first-serve (FCFS) basis, that in turn may update the status of the database 108. Typically, pricing decisions and checks for non-contracted spot shippers, and customers with long term contracts may be determined at block 312. Alternatively, if in either case sufficient or appropriate liner slots, containers and other capacities and resources are not available for allocation, or the pricing is not acceptable to the shipper, the method 300 moves to block 316.

In an implementation, the order management system 102 may also support negotiations, if required. At block 316, it is determined whether the customer is willing to negotiate the due date, quantity, and type and arrive at a mutually-agreeable order or set of orders or not. If yes, the method 300 moves to block 318 for the on-line or off-line negotiations. The negotiations may include due date or back ordering negotiations that typically postpone the date of shipment. Quantity negotiations may include options for splitting the order with multiple due dates subject to minimum lot sizes. Further, type negotiations may identify substitutable capacities and resources that may be allocated. If due date changes may impact pricing, the same will be an element in the discussions. Accordingly, alternation in orders, changed order, re-entry, partial booking, upgrading of the order, or any other dynamic customer-preferred options may be discussed or negotiated at the block 318. Furthermore, at block 318 it is also checked if a more profitable allocation plan is acceptable to the customer instead of the requested order. Thus, an alternative booking options may be provided to the customer for confirmation. Based on acceptance of a particular option by the customer, the order or its components are reprocessed.

Again referring to block 316, if the customer is not willing to negotiate, the method 300 moves to block 320 and the order is rejected. In an implementation, only historical information of rejected orders is kept in the database 108, inventory status updates may merely change to reverse any temporary hold on the assets for the negotiations.

Further, at block 306, if the analyzer module determines that the lead time is not less than the user-configurable lower threshold the method 300 moves to block 322. At block 322, the analyzer module further determines if the lead time exceeds a user-configurable upper threshold or not. If yes, the method 300 may invoke a similar workflow sequence from block 310 to block 314, as described above. It will be understood that the workflow sequence from block 310 to block 314 is described above and is not described again for the sake of brevity. At block 322, it is determined that the lead time does not exceed a user-configurable upper threshold, the method 300 moves to block 324. At block 324, it is determined if the demand is more than what can be reliably serviced. If yes, the order management system 102 may insert the order or booking request into a batch for the appropriate time bucket.

All orders in the batch will be processed periodically and sequentially at block 326 at the end of the user-configurable time period. Further, at block 328, it is determined if order is valuable and serviceable by the service provider. If yes, the order is accepted else the order is rejected. Thus, those orders deemed definitely valuable and service-able would be confirmed via block 314, while those that are definitely not serviceable or are not valuable may be rejected via block 320. In case there exists some possibility of negotiations, the method 300 moves to block 316. The order management system 102 may be configured for the renegotiation of some orders, for example, some of orders that are just below an accept/reject threshold at block 326. The renegotiation of orders may invoke the workflow sequence from blocks 316 to block 318, whereby the renegotiated orders get evaluated afresh.

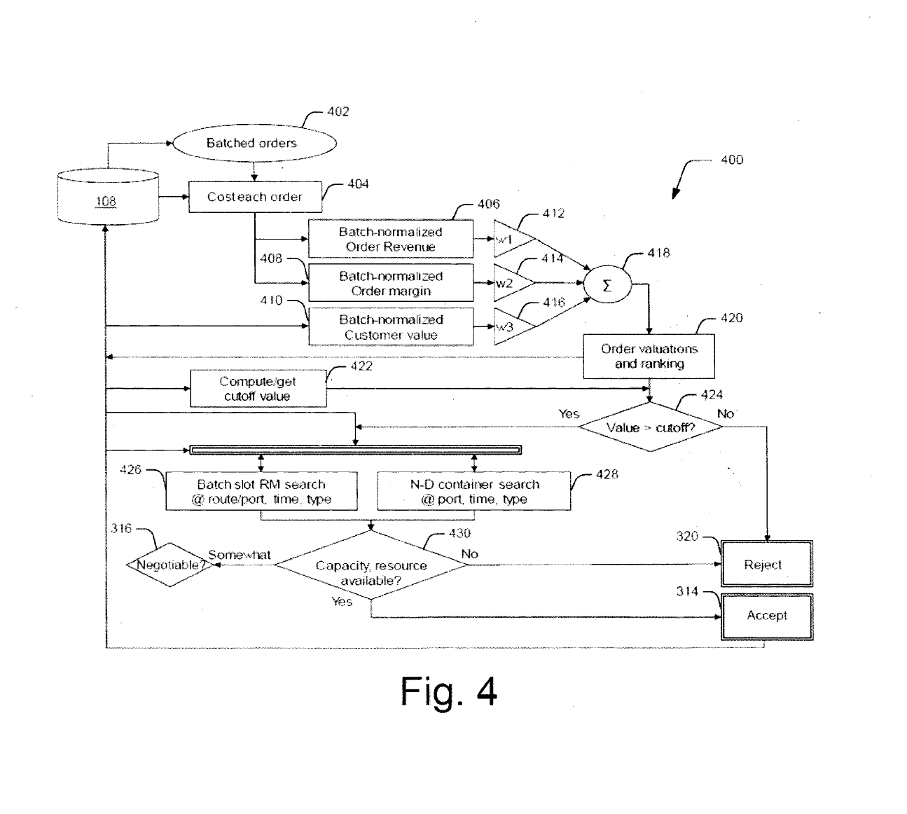

FIG. 4 shows a flowchart illustrating a method 400 for order selection during batch processing, in accordance with an embodiment of the present subject matter. The method 400 may be described in general context of computer executable instructions. Generally, computer executable instructions can include routines, programs, objects, components, data structures, procedures, modules, functions that perform particular functions or implement particular abstract data types. The method 400 may also be practiced in a distributed computing environment where functions are performed in geographically-structured organizations typically seen in liner companies, by remote processing devices that are linked through a communication network. In a distributed computing environment, computer executable instructions may be located in both local and remote computer storage media, including memory storage devices.

The order in which the method 400 is described is not intended to be construed as a limitation and may be performed in various ways. Moreover, any individual method block may include various sub-steps that may be performed in different ways to implement the method 400 or alternative methods. Additionally, individual blocks may be combined or deleted from the method 400 without departing from the spirit and scope of the subject matter described herein. Further, the different ways to implement the method 300 may be obvious to a person skilled in the art. Furthermore, the method 400 can be implemented in any suitable hardware, software, firmware, or combination thereof.

In an implementation, FIG. 4 details the batch process taking place at block 326 as explained in conjunction with FIG. 3. The method 400 starts at block 402 with the periodic processing of a batch of orders comprising all the booking requests that were received in the user-configurable time interval covered by the batch. If demand & booking requests are segmented, such as in express and ordinary classes, the segments are segregated and processed in descending order of priority, for example, first the express and then the ordinary. Further, at block 404, financial contributions of each order are fully analyzed and estimated. The financial contributions may include the revenue and margin generated. The orders in the batch segment are then ranked in descending order of their values.

The method 400 may further include normalization over all orders during the batch process. At blocks 406, 408, and 410, the revenue, margin, and long term business expectations from customers are normalized respectively. Further, at blocks 412, 414, and 416 the normalized values may then be multiplied by user-configured weights. At block 418, the multiplied values may be summed. This may provide the expected integrated value or contribution of each order pattern. Accordingly, at block 420, the various orders may be provided specific values and corresponding rankings. It will be evident to those skilled in the art that valuing orders in this exemplar manner integrates long-term customer and short-term order contributions, as well as the service-provider's policies on business valuation and variants of the system and methods may be used to capture similar but different configurable valuation choices.

In an implementation, at block 422 an order value cutoff may be computed for each type of order in a batch. The cutoff is based on an analysis of orders of similar descriptions. This process can involve a user-customized process, such as automated supervised machine learning techniques. The machine learning techniques may include inductive learning of decision trees from actual historical business in the database 108 or semi-automated methods reinforcement learning from simulated and labeled examples of accepted and rejected orders. In the process to learn the threshold, some historical or simulated orders may also get randomly accepted with a user-configured probability, if they are within a user-specified range below the threshold value. This accounts for noise in the data or the decisions made with the example cases. It is clear to those skilled in the art that the method 400 of accepting orders estimated threshold value for acceptance, the values of new orders are continuously increased and variants of the same can be used to evaluate orders in the batch process. It is also clear that the present subject matter may also be used to improve the filtering of decidedly unprofitable orders in the intrinsically first-come-first-serve promising of orders at block 310.

Further, at block 424, it is determined if the value of an order is greater than the cutoff or not. If the value of the order is greater than the cutoff, the method 400 moves to blocks 426 and 428. The orders are sequentially accepted in a descending order of their values. The values of the remnant orders are adjusted whenever an order is accepted. As values are adjusted every time an order is accepted, it improves the contribution of all orders given the remnant liner slots, containers and other capacities and resources available.

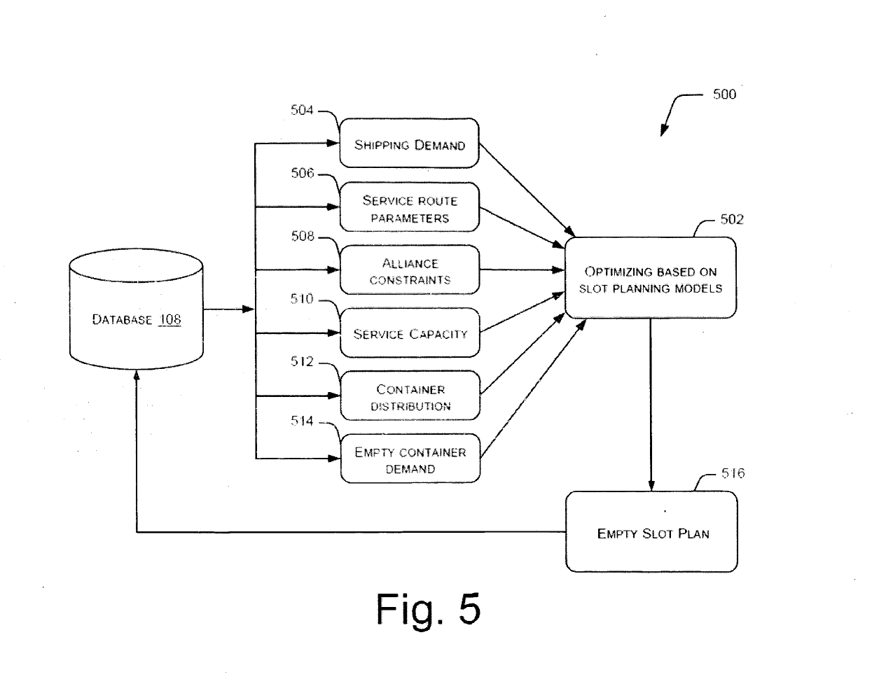

In an implementation, at block 426, the order management system 102 may conduct a systematic search for empty liner slots and other capacities that may be allocated to the possibly segmented orders awaiting booking confirmation, each with at least an origin, destination, range of dates for delivery at destination, and number and types of containers or other resources. The block 426 implements the principles of revenue management to maximize short-term revenue and profit in the choice of empty liner slots available for allocation to orders. Further, at block 426 it is ensured that physical capacity constraints on the maximum number of liner slots or the weight carried by the liner are not violated while maximally meeting business preferences, such as extent of shipping requests serviced, including both those in the batch and ones expected at future time periods, or the extent of alliance partners obligations met. Depending on various constraints, the order management system 102 may consider all possible routes, including involving transshipment and equipment substitutions. Details about the liner empty slot planning have been explained later in conjunction with FIG. 5.

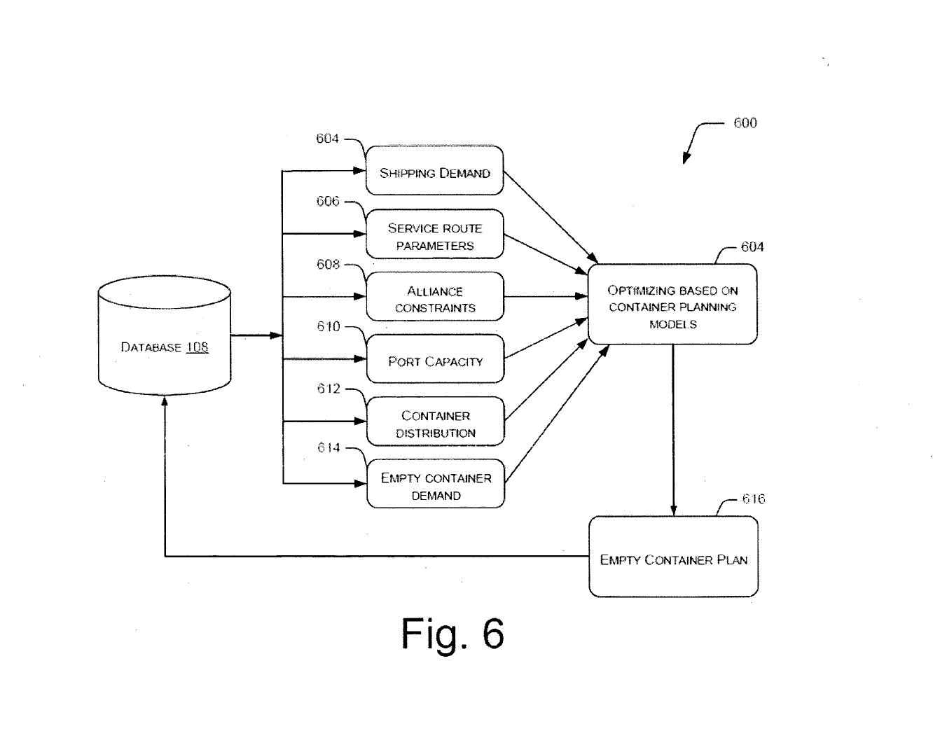

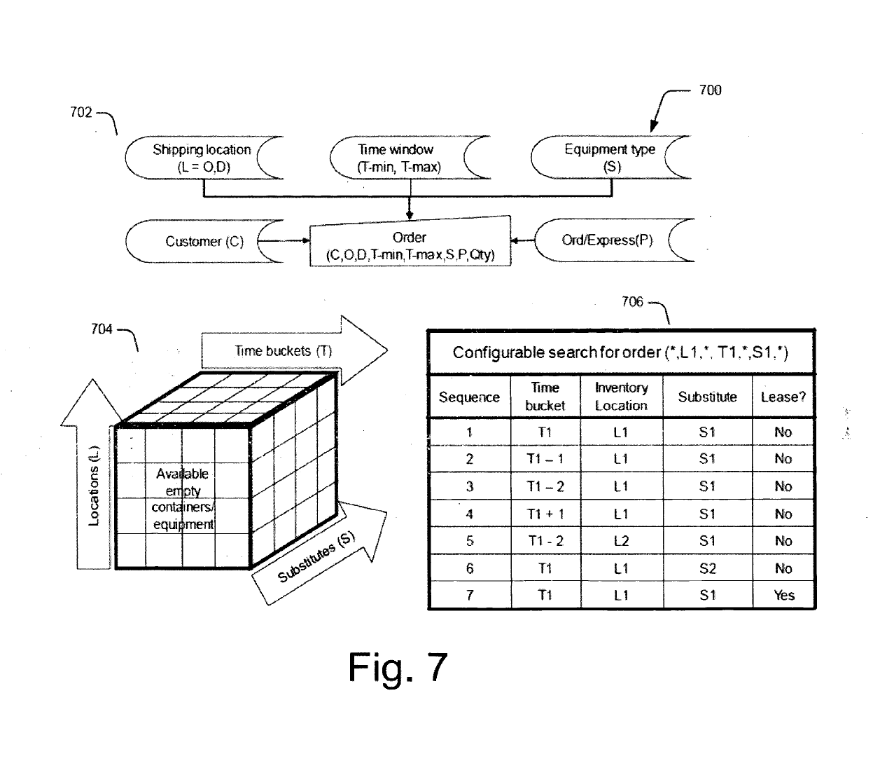

Further, at block 428, the order management system 102 may conduct a systematic user-configurable multi-dimensional search for empty containers and other available-for-allocation resources, in the numbers, of the types and within the time periods requested by the orders. The search examines the remnant availabilities of containers from the tactical reservations first allocated at block 216 by the tactical module 132 and updated continuously at block 226 by the tracking module 124, within their multi-dimensional distribution by, for example, planning time buckets, geographic locations and substitutable types. Such searches may be augmented by occasional short-distance intra-regional reposition. Details about the empty container re-distribution and sequential search for containers have been explained later in conjunction with FIGS. 6 and 7. Accordingly, the search conducted at blocks 426 and 428 supports the order serviceability computation by the order management system 102.

Additionally, at block 430, it is determined whether the capacities and resources are available for a particular order or not. If yes, the method 400 moves to block 314 for accepting the order. Else, the method 400 moves to block 320 for rejecting the order. Further, to determine if there is any scope of negotiations, the method moves to block 316. Accordingly, at block 430, the same as block 316, sequential validation of availability of capacities and resources for the orders in the batch is completed.

FIG. 5 shows a flowchart illustrating a method 500 for liner empty slot planning, in accordance with an embodiment of the present subject matter. The liner empty slot planning may be understood as an embodiment of the batch slot RM search as described with reference to block 426. The liner empty slot planning is evaluated at block 502. The forecasting and planning module 120 may plan the liner empty slots based on information retrieved from the database 108. Block 502 may receive inputs, such as future demand expectations already booked from one or more demand segments, required container and resource types, quantities, and expectations based on time periods at block 504. Further, at block 506, information regarding supply side availability and constraints regarding service routes & frequencies, liner capacities based on type and deadweight tonnage (DWT) is provided to the forecasting and planning module 120. Furthermore, information about liner capacities based on type and deadweight tonnage (DWT) of the liner is shared as shown at block 510.

The method 500 also facilitates input of information related to geographic and temporal distributions of containers based on the continuous movements of full and empty equipment as depicted in block 512. The distribution of the containers may be tracked based on types of containers, based on a pre-defined time period and the like. Additionally, information about various internal requirements for empty container movements and other similar information and data are also input as shown in block 514 Information about type of assets, such as own or alliance asset may be provided at block 508. It will be evident to a person skilled in the art that the information taken at blocks 504 through 514 is retrieved from the database 108.

The forecasting and planning module 120 may then apply a customized optimization algorithmic process to compute the temporal and service-specific distribution of empty slots on liners on a service route for servicing orders by origin-destination. This computation for the liner slot/capacity temporal & geographic distribution by service may be performed using company-customized methods from a system-supported selection. Examples of the company-customized methods may include use of linear programming, integer programming, constraint propagation, heuristics, meta-heurists, or combinations thereof. Accordingly, at block 516, the forecasting and planning module 120 may accumulate empty slot plans for different routes and services. The computation as described above may maximize financial returns to the shipping logistics service provider and the service reliability to the customers. The method 500 may optimize the result in a static single-period or a dynamic multi-period implementation. The information provided at block 502 from the database 108 may be reconfigured for providing tactical as well as the operational plans. Further, the empty slot plan may be uploaded into the database 108.

FIG. 6 shows a flowchart illustrating a method 600 for redistribution planning of empty containers and other logistics equipment or resources, in accordance with an embodiment of the present subject matter. The present figure may provide plan for empty container redistribution planning in inter/intra regions. At block 602, computation for empty container redistribution is done. The computation at block 602 may be performed based on inputs shared from block 604. The inputs may relate to future demand expectations and already booked of possibly one or more demand segments, required container and resource types, quantities, by time periods, by demand segment, and the like. At block 608, data about the availability of transport capacity from own and alliances is provided to block 602.

Further, at block 606, information pertaining to supply side availability and constraints regarding valid service routes between all ports of operation, their capacities, transit times, and costs for different empty or loaded container of different types is provided for computation of the empty container plan. Accordingly, information related to different storage capacities, costs associated with planned safety stocks by port, current, in-transit and expected temporal and geographic distributions of containers, due to the continuous movements of full and empty equipment, by type of container, over time; internal requirements for empty container movements; and other similar information and data are also input at blocks 610, 612, and 614 respectively. It will be evident to a person skilled in the art that the information provided to block 602 for computation of the empty container plan is retrieved from the database 108. The computation then applies a customized optimization algorithmic process to compute the temporal and service-specific distribution of empty slots on liners on a service route for servicing orders by origin-destination.

This computation for the temporal and geographic distribution of containers and other resources of all types may be performed using company-customized methods from a system-supported selection. The company-customized methods may include the use of linear programming, integer programming, constraint propagation, heuristics and meta-heurists, or combinations thereof. The computation as described above may maximize the financial returns to the shipping logistics service provider and the service reliability to the customers. The method 600 may optimize the result in a static single-period or a dynamic multi-period implementation and may provide the empty container plan at block 616. Reconfiguration of the data inputs from block 604 through block 614 into the block 602 may cover the tactical as well as the operational order management plans. As mentioned above, the method 600 may be invoked when the search at block 428 requires an intra-regional reposition. Further, the empty container plan may be uploaded into the database 108.

FIG. 7 shows a flowchart illustrating a method 700 for sequential N-dimensional (ND) search before booking an order, in accordance with an embodiment of the present subject matter. In an example, the order may include, but is not limited to, any request for a logistical shipping service, such as the transportation of the manufactured goods, freight, cargo, etc., over a plurality of ocean path and from one location to another.

Such orders may be fulfilled by the logistics company using various assets, such as resources like tank containers, 20 and 40 feet dry box or flat rack containers, and reefer containers. Further, the inventories of the logistics company may be created at specific selected static locations. Additionally, the mobile capacities or carrier may include, but are not limited to, liners of different types, sizes and DWT, liner slots of different types, barges, trucks, trains, local depots and storages. It will be understood that one class of assets are generally used to transport the other class of assets, and references to assets include references to both types—capacities and resources.

The N-D search may be performed for containers and other logistic equipments and resources. Block 702 may depict the description and composition of customer shipment requests that become orders after promising. Each shipment request contains, among other details, customer identification information, the origin & destination of the shipment, the time window for delivery of the loaded container(s) at the destination or the receipt of empty container(s) at the origin and the type and number of container(s) or equipment desired and acceptable substitutes. While a shipment may involve multiple legs, for the sake of brevity we describe only the main ocean leg. It will be evident to a person skilled in the art that the description may be extended to cover, for example, multi-modal inland transportation from the shipper site to the origin port or from the destination port to the receiver's site.

Block 704 may illustrate the availabilities and demand segment reservations of containers and equipments in a plurality of dimensions, including of time, location and substitute type that may be computed while determining container reservations and container availability at blocks 216 and 218 respectively. This 3D map of availabilities, including reservations for demand segments, is specific for each port of operation and for each type of container. The granularity in the temporal dimension is user-configurable that may be determined primarily by the frequency of services from the port.

In an implementation, search for containers or equipment that may satisfy a booking request is performed on this 3D distribution using the user-configurable table 706. The table 706 may be stored in the database 108 and one copy of the table 706 may exist for each copy of the 3D space 704. Each row in the table 706 represents one specific cell in the corresponding 3D space. The order of the rows may specify the order in which the 3D space is searched until the required number and type of container(s) is found for the desired time period. It an implementation, one row of the table 706 may represent one cell of the 3D space 704 that may provide a part of the booking request. The search for the remaining part of the booking request may continue down the rows if the booking request allows split orders and the matching quantities found in each cell are at least as numerous as the minimal shipment quantity specified in the booking request. The type of substitutes located in a cell of the 3D space should match the substitutes allowed in the request. When demand is high, the search may not be able to complete the booking request, completely or partially, when the last row in the table 706 has been searched. The order is then re-negotiated or rejected.

In another implementation, the 3D space 704 and the table 706 may support searches for determining availability of more than one type of containers, logistics equipment or other resources, as order for booking requests may require more than one asset that may be of different types. For example, a shipping request may require at least one container and at least one tractor trailer, which may belong to different asset types. In such cases, the availability of containers can be separately checked from the availability of the trailers.

The three dimensional search for containers and other logistic equipments and resources depicted in FIG. 7 may not to be construed as a limitation but merely an example. Further, resource search components, such as the multi-dimensional space 704 and the table 706 may be used to implement a multi-dimensional search for containers, where the N-dimensions may be time, location, substitutable resources, whether to use own or leased or alliance resources, as depicted in the table 706, and so on. In one implementation, the N-dimensional search may be a 3-dimensional search with dimensions of time, location, substitutable assets, where time refers to a sequence of dispatch day, location refers to a hierarchical control or multiple sourcing area(s), and substitutable assets refer to assets with high levels of commonality and compatibility in terms of serving an order. For example, two 20 feet containers may substitute one 40 feet container.

The sequence in which the dimensions are searched in the table 706 should not intended to be construed as a limitation. Moreover, any number of the dimensions can be searched in any sequence to perform the multi-dimensional search. Additionally, any relevant dimension may be added or deleted to perform the multi-dimensional search without departing from the spirit and scope of the subject matter described herein.

None of the systems disclosed in the patent are limited to any particular type of computing, storage, communications or display hardware, system and/or environmental software like operating systems, database management systems, communications protocols, file or message formats and can be developed and deployed based on custom user specifications or on standardized platforms or architectures. All analytical, forecasting, planning or scheduling systems are typically implemented on hardware with high processing speeds and local memory, while the algorithms use tools or methods whose response match user requirements for responsiveness in order management. Any specific names of systems and methods are only examples that depict viable options.

In an implementation, by integrating revenue management for perishable capacities; a systematic management of the inventory and reservations of the distributed resources; a controlled ND search of the availabilities; and integrated order promising and fulfillment, the order management system 102 ensures that shipping service providers can make best use of opportunities to achieve higher revenues and margins from more scientific allocations of their expensive assets. Further, the present subject matter may facilitate the shipping logistics service providers to improve the service level provided to the customers, the shippers, subject to service level agreements (SLA) and other business/operational constraints.

Further, all systems-generated order management plans, strategic, tactical or operational, for liner slots, containers or other capacities and resources may be manually modified or changed prior to implementation. While this may enhance plan implementability, such changes may not ensure optimality of returns or of customer service levels.

Thus, the order management system 102 may enable service providers to profitably manage market demand with varied revenue contribution expectations. More particularly, even service providers who have a continuous flow of stochastic and geographically-unbalanced demand, uncertain supply and allocation, geographic hierarchy of operations, substitutable resources, and/or a segmented market can manage order promising and fulfillment based on maximizing revenue, profitability and the reliability of customer services.

Although the implementations for the order management system have been described in language specific to structural features and/or methods, it is to be understood that the present subject matter is not necessarily limited to the specific features or methods described. Rather, the specific features and methods are disclosed as exemplary implementations for the order management system.

I/We claim:

1. An integrated method for managing shipment orders in liner based services, the method comprising:
receiving at least one request for booking a shipment order, wherein the shipment order comprises booking at least one empty liner slot and at least one empty container;
determining, based on an operational order management plan, temporal and geographical availabilities of empty liner slots and empty containers to promise the at least one request, wherein the operational order management plan is generated by:
analyzing forecasts and actual status of demand and availabilities of empty liner slots and empty containers over immediate time horizons as stored in a database;
adapting availabilities and reservations, based on evaluations, of the at least one empty liner slot in accordance with an empty slot plan, wherein the empty slot plan is based at least on revenue management and optimization of one or more variables; and
evaluating and adapting multi-dimensional availabilities and reservations of the at least one empty container in consonance with an empty container plan, wherein the empty container plan is based on a configurable search over the multiple dimensions and optimal intra-regional repositioning of empty containers;
providing a response to the at least one request, based on the determination, wherein the response comprises one of an acceptance of the at least one request, a negotiation of the at least one request, and a rejection of the at least one request; and
executing the at least one request upon the acceptance of the at least one request, wherein the executing comprises updating information related to the at least one empty liner slot and the at least one empty container.

2. The method as claimed in claim 1, wherein the operational order management plan is derived from a predictive tactical order management plan, the predictive tactical order management plan being generated by,
analyzing forecasts and actual status of demand and availabilities of empty liner slots and empty containers over intermediate time horizons as stored in the database;
evaluating and adapting the availabilities and reservations of the at least one empty liner slot based at least on revenue management and the optimization of one or more variables; and
evaluating and adapting the multi-dimensional availabilities and reservations of the at least one empty container based on optimal inter-regional repositioning of the empty containers.

3. The method as claimed in claim 2, wherein the predictive tactical order management plan is periodically updated based on the forecasts and actual status of orders, empty containers, and empty liner slots as stored in the database.

4. The method as claimed in claim 2, wherein the predictive tactical order management plan is derived from a predictive strategic order management plan, the predictive strategic order management plan being generated by,
analyzing long-term expectations of shipping demands; and
determining supply response based on the analysis for planning temporally & geographically-distributed acquisition and deployment of capital assets in markets to be serviced.

5. The method as claimed in claim 4, wherein the predictive strategic order management plan is periodically updated based on the forecasts of orders, empty containers, and empty liner slots as stored in the database.

6. The method as claimed in claim 4, wherein the capital assets include at least one of a liner, a liner slot, and a container.

7. The method as claimed in claim 1, wherein the determining comprises identifying a priority status of the at least one request and providing a reserved empty liner slot and a reserved empty container based on the priority status of the request.

8. The method as claimed in claim 1, wherein the determining further comprises assessing the at least one request for one of an advance booking and a late booking.

9. The method as claimed in claim 1 further comprising updating the operational order management plan based on the execution of the at least one request, wherein the forecasts and status of all orders, empty containers, and empty liner slots are stored in the database.

10. The method as claimed in claim 9, wherein the operational order management plan is updated on one of a periodic basis and an on-demand basis.

11. An order management system for managing shipment orders in liner based services, the order management system comprising:
a processor; and
a memory coupled to the processor, the memory comprising:
a forecasting and planning module configured to,
analyze long-term shipping demands and generate a predictive strategic order management plan based on the analysis;
determine demand and supply of the logistic capacities over intermediate time horizons and generate a predictive tactical order management plan based on the determination, wherein the predictive tactical order management plan is generated in accordance with the predictive strategic order management plan; and
generate an operational order management plan by combining immediate-term forecasts and at least a request for booking a shipment order, wherein the operational order management plan is based on the predictive tactical order management plan; and
an order promising and fulfillment module configured to,
receive at least one request for booking a shipment order, wherein the shipment order comprises booking at least one empty liner slot and at least one empty container;
determine, based on the operational plan, temporal and geographical availabilities of empty liner slots and empty containers to promise the at least one request; and
provide a response to the at least one request, based on the determination, wherein the response comprises one of an acceptance of the at least one request, a negotiation of the at least one request, and a rejection of the at least one request.

12. The order management system as claimed in claim 11, wherein the forecasting and planning module comprises a strategic module, the strategic module configured to,
determine supply-side response of the long-term shipping demands; and
develop a plan based on the supply-side response for temporally & geographically-distributed acquisition and deployment of capital assets in a selected shipping market.

13. The order management system as claimed in claim 11, wherein the forecasting and planning module comprises a tactical module, the tactical module configured to,
analyze demand and supply forecasts of empty liner slots and empty containers over intermediate time horizons; and
evaluate the availabilities and reservations of at least one empty liner slot based at least on revenue management and the optimization of one or more variables; and
compute multi-dimensional availabilities and reservations of at least one empty container based on inter-regional repositioning of the empty containers.

14. The order management system as claimed in claim 13, wherein the forecasting and planning module comprises an operational module, the operational module configured to identify logistic capacities and resources to be allocated to the at least one request.

15. The order management system as claimed in claim 11, wherein the order promising and fulfillment module is further configured to,
evaluate optimal availabilities and reservations of the at least one empty liner slot in accordance with an empty slot plan, wherein the empty slot plan is based at least on revenue management and optimization of one or more variables and one or more parameters; and
compute optimal multi-dimensional availabilities and reservations of at least one empty container in consonance with an empty container plan, wherein the empty container plan is based on a configurable search over multiple dimensions and optimal intra-regional repositioning of empty containers and one or more parameters.

16. The order management system as claimed in claim 15, wherein the one or more parameters comprise at least shipping demand, service routes, liner capacity, empty container demand, port capacity, types of containers, and associated cost.

17. The order management system as claimed in claim 11 further comprising a tracking module configured to update as rapidly as possible a database upon detecting any change in data associated with the shipping logistics service provider.

18. The order management system as claimed in claim 17, wherein the database is configured to store one or more of historical and live shipment booking requests, logistic details, financial details, customer details, allocations, availabilities, and a plurality of configuration parameters.

19. A computer-readable medium having embodied thereon a computer program for executing a method for managing shipment orders in liner based services, the method comprising:
receiving at least one request for booking a shipment order, wherein the shipment order comprises booking at least one empty liner slot and at least one empty container;
determining, based on an operational order management plan, temporal and geographical availabilities of empty liner slots and empty containers to promise the at least one request, wherein the operational order management plan being generated by:
analyzing forecasts and actual status of demand and availabilities of empty liner slots and empty containers over immediate time horizons as stored in a database;
adapting availabilities and reservations, based on evaluations, of the at least one empty liner slot in accordance with an empty slot plan, wherein the empty slot plan is based at least on revenue management and optimization of one or more variables; and
evaluating and adapting multi-dimensional availabilities and reservations of the at least one empty container in consonance with an empty container plan, wherein the empty container plan is based on a configurable search over the multiple dimensions and optimal intra-regional repositioning of empty containers;
providing a response to the at least one request, based on the determination, wherein the response comprises one of an acceptance of the at least one request, a negotiation of the at least one request, and a rejection of the at least one request; and
executing the at least one request upon the acceptance of the at least one request, wherein the executing comprises updating information related to the at least one empty liner slot and the at least one empty container.
